(19) United States
(12) Patent Application Publication
(10) Pub. No.: US 2018/0172181 A1
(43) Pub. Date: Jun. 21, 2018

(54) UNIVERSALLY-ORIENTED G-CLIP

(71) Applicant: Tifany June Leigh-Logan, Willits, CA (US)

(72) Inventor: Tifany June Leigh-Logan, Willits, CA (US)

(21) Appl. No.: 15/387,558

(22) Filed: Dec. 21, 2016

(51) Int. Cl. F16L 3/16; A61G 7/05; F16B 2/22; F16M 13/02; F16L 3/12

(52) U.S. Cl. CPC F16L 3/16; A61G 7/05; F16L 3/1218; F16M 13/022; F16B 2/22

(57) ABSTRACT

Applicant provides a unique hanger assembly generally comprising a snap-on spring element enabled to engage and disengage a round tubing, conduit or rail, and once engaged to remain in place until manually disengaged, the snap-on spring element having a first axis. This embodiment further comprises a hanger element providing an open loop adapted to support a loose wire or tubing, the loop having a central plane. An interface assembly is provided joining the snap-on spring element and the hanger element, the interface assembly having a first and a second portion joined by a spring-loaded pivot mechanism having a pivot axis oriented at a right angle to the first axis of the snap-on spring element and lying in the central plane of the hanger element. A mechanism is provided enabling the first and second portions to be rotationally disengaged, rotated, and re-engaged in a plurality of fixed rotational increments.

### BACKGROUND OF THE INVENTION

### 1. Field of the Invention

The present invention is in the technical area of devices for supporting tubings and wires in otherwise cluttered circumstances, and pertains more particularly to a clip on support that has a hanger that may be rotated to incremental positions.

### 2. Description of Related Art

There are many circumstances and situations in which several different apparatuses that may have wires or tubes may be employed at the same time. An example is in a hospital bedside situation, where a patient in a hospital bed may be intubated, and there may be several instances of diagnostic and/or monitoring apparatuses used. In such a situation electrical wires and tubes may become entangled, and it becomes difficult to keep track of what tubes and wires belong to which equipment.

Additionally, sanitation of the electrical wires and tubes are of great concern in hospital and medical environments as incidents of resistive bacterial infections increase. It is known that in many such circumstances there are railings, stands and frames that typically incorporate round tubing supports, such as bed rails, lamp stands, Intravenous (IV) stands and the like. What is needed is a universally-oriented G-clip that may be quickly and easily snapped onto rails and other frame elements as supporting elements, such that the G-clip may be vertically-oriented, regardless of the orientation of the supporting elements. With such a solution, wires and tubes may be routed and supported in a manner that keeps them in order and out of entanglement.

### BRIEF SUMMARY OF THE INVENTION

Applicant provides a unique hanger assembly generally comprising a snap-on spring element, being a structure enabled to engage and disengage a round tubing, conduit or rail, and once engaged to remain in place until manually disengaged, the snap-on spring element having a first axis. This embodiment further comprises a hanger element providing an open loop adapted to support a loose wire or tubing, the loop having a central plane. An interface assembly is provided joining the snap-on spring element and the hanger element, the interface assembly having a first and a second portion joined by a spring-loaded pivot mechanism having a pivot axis oriented at a right angle to the first axis of the snap-on spring element and lying in the central plane of the hanger element. A mechanism is provided enabling the first and second portions to be rotationally disengaged, rotated, and re-engaged in a plurality of fixed rotational increments.

One embodiment also includes that the open loop of the hanger element further comprises a lip element extending towards the interface assembly thereby partially closing the loop. The hanger assembly may also include that one portion of the interface assembly has a circular pattern of holes around the pivot axis, and the other portion has a plurality of pins in the same circular pattern as the holes, and the rotational increments are defined by the number of holes and pins in the circular pattern.

An alternative embodiment provides that the snap-on spring element comprises a cylindrically-curved section of a flexible plastic material, having a length and an inside radius of curvature, the wall spanning an arc of more than 180 degrees but less than 270 degrees, such that the snap-on element may be urged onto a tubing, conduit or rail, expanding the radius of curvature until the snap-on element fully engages the tubing, conduit or rail.

In another embodiment of using the hanger element a rotational adjustment is made by pulling the second portion of the interface element away from the first portion, against a spring force of the spring-loaded pivot mechanism, disengaging the pins from the holes in the portions, rotating one portion relative to the other to a new rotational position, and allowing the spring to urge the two portions back together, with the pins engaging the holes.

A method for routing and supporting a loose wire or tube is provided in one embodiment comprising steps engaging a hanger assembly by a snap-on spring element having a first axis to a round tubing, conduit or rail, presenting thereby a hanger element having an open loop in a first plane connected to a rotationally-adjustable interface assembly, away from the tubing, conduit or rail. Disengaging a first portion of the interface assembly from a second portion against a spring force of a spring-loaded pivot mechanism, thereby disengaging the first portion from the second portion rotationally; rotating the first portion relative to the second portion until the plane of the loop is substantially vertical. Then a next step is provided releasing the first portion against the spring force to re-engage with the second portion, constraining the plane of the loop to remain vertically-oriented, and finally, hanging a loose wire or tube in the loop. The method also includes various embodiments presented, above, for the hanger apparatus.

### BRIEF DESCRIPTION OF THE SEVERAL VIEWS OF THE DRAWINGS

FIG. 1 is a perspective view of a G-clip in an embodiment of the present invention.

FIG. 2 is an elevation view of the G-clip of FIG. 1.

FIG. 3 is an elevation view of the G-clip from a different viewpoint than that of FIG. 2.

FIG. 4 is an end view of the G-clip of FIGS. 1-3.

FIG. 5 is an end view of the G-clip in an embodiment of the invention illustrating orientation elements.

FIG. 6 is a flow diagram illustrating steps in using the G-clip of FIGS. 1-5.

### DETAILED DESCRIPTION OF THE INVENTION

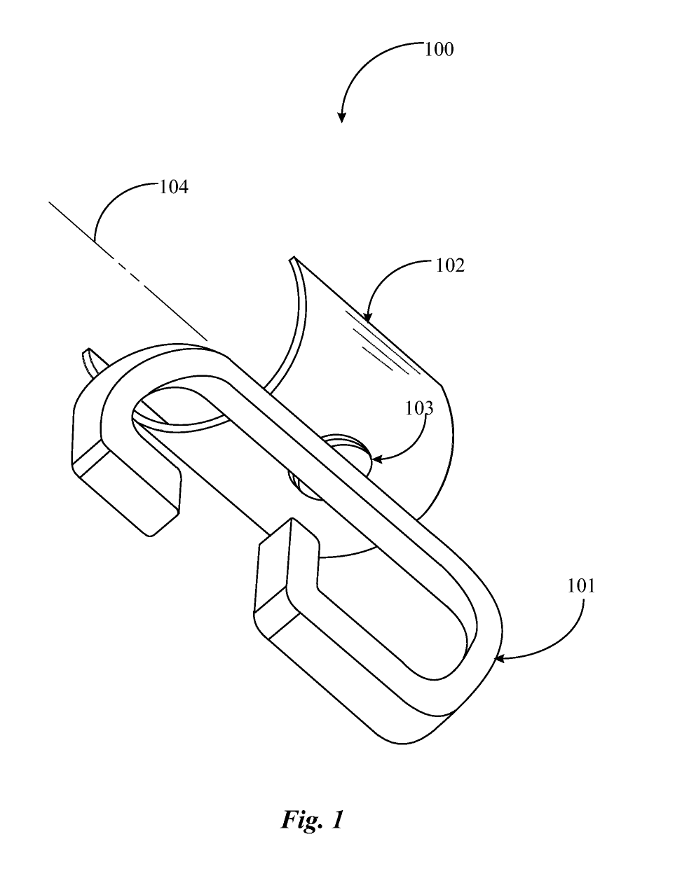

FIG. 1 is a perspective view of a G-clip 100 in an embodiment of the present invention. G-clip 100 in this embodiment comprises a hanger 101 in roughly a shape of a letter G, a snap-on spring element 102, adapted to engage and clamp to a round rail, tubing or conduit, and an interface assembly 103, joining the hanger and the snap-on spring element in a manner that the orientation of a central plane of the hanger may be adjusted relative to an axis 104 of the snap-on spring element. Orientation adjustment is described in enabling detail below.

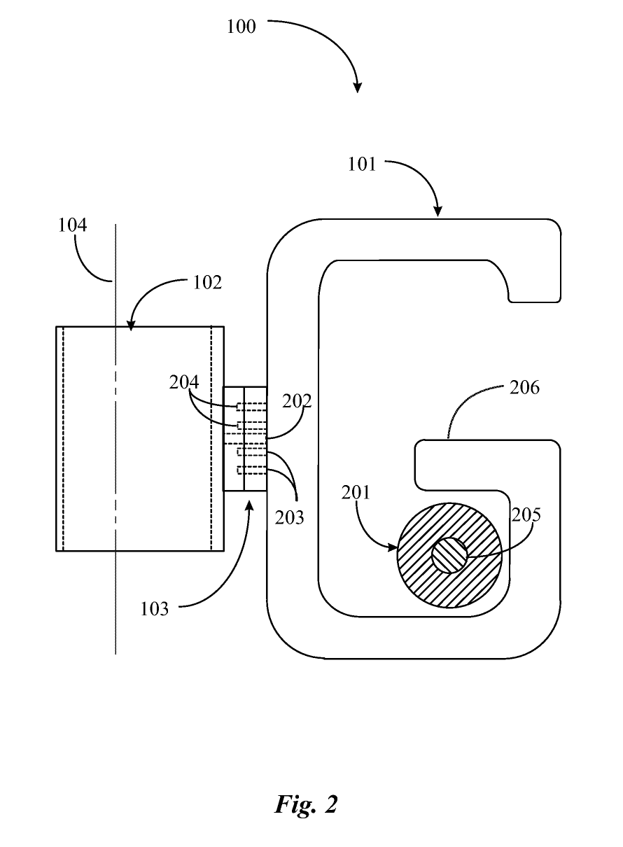

FIG. 2 is an elevation view of the G-clip of FIG. 1. In this view both the axis of snap-on spring element 102 and the plane of hanger 101 are vertically oriented. In this circumstance the G-clip might be snapped on to a vertically oriented tube, rail or conduit, which would then support the G-clip with hanger 101 vertical, such that an electrical wire 201, having a central conductor 205, as an example, that might be supported and constrained by the G-clip. It is to be understood that electrical wires are an important, but not limiting example of elements that might be routed, supported and constrained by a plurality of G-clips snapped on to rails, tubes and conduits in a variety of positions and orientations. Note that lip 206 of hanger 101 serves to retain wire 201, requiring intentional manipulation to disengage wire 201 from hanger 101. In an embodiment of the invention hanger 101 may be rotated about a pivot axis 207 relative to the snap-on spring element thereby maintaining the plane of the hanger at vertical, allowing force of gravity to maintain the wire 102 within the hanger.

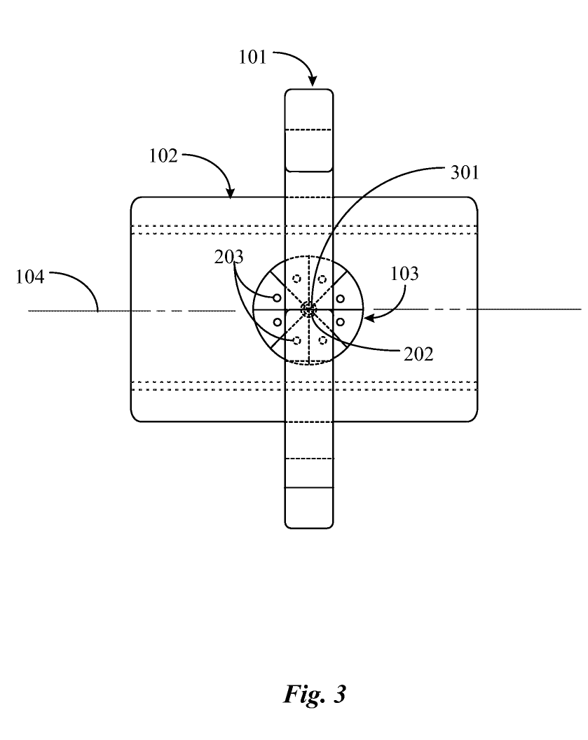

FIG. 3 is an elevation view of G-clip 100 from a different viewpoint than that of FIG. 2. In the view of FIG. 3, snap-on spring element 102 is oriented at ninety degrees to the plane of hanger 101, such that axis 104 is horizontal, and the plane of hanger element 101 is still vertical. In this circumstance, snap-on spring element 102 may engage a tube, conduit or rail that is horizontally disposed, while still maintain the plane of hanger 101 vertically. The change in relative orientation between snap-on spring element 102 and hanger 101 is accomplished by operation of interface assembly 103. Interface assembly 103 provides a central pivot pin 202 around which elements 102 and 101 may rotate. One part of interface assembly 103 has a pattern of pins, in this instance a circular pattern centered on pivot pin 202, which may mate with a pattern of holes (not shown in FIG. 3).

The fact of a plurality of pins and holes in a common pattern, in this example, eight each, allows hanger 101 to be oriented relative to snap-on spring element 102 in increments of forty-five degrees. In other embodiments, a different number would enable a different incremental orientation. Thirty-six holes and pins, for example, would enable orientation in increments of ten degrees; twelve holes and pins allow 30 degree increments, etc. The present invention is not necessarily limited by pin and hole count. The higher the pin/hole count the more flexibility the hanger position has to remain vertical no matter what orientation the tubing that spring element 102 is attached to.

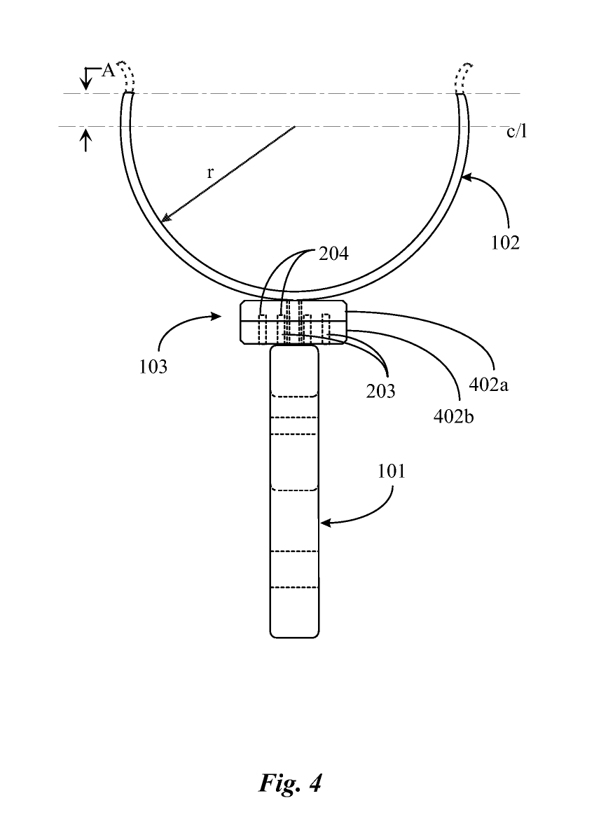

FIG. 4 is an end view of G-clip 100 of FIGS. 1-3, along the axis 104 of snap-on spring element 102, illustrating additional detail of both the interface assembly 103 and of the snap-on spring element 102. Snap-on element 102 is in the shape of a partial circle, encompassing somewhat more than one-half of the circle. The line labeled c/1 is a centerline of the circle shape of snap-on spring element 102, which has a radius “r”. In this example the snap-on spring element is made to engage a rail, tube or conduit that has a diameter a bit greater than 2r. The difference causes the snap-on spring element to engage with some force, so the engagement is secure. The shape of snap-on spring element 102 continues past centerline by a dimension A, which may vary in different embodiments, so the anchor rail, tube or conduit is firmly gripped. In some cases there may be an opening shape, shown in FIG. 4 with dotted lines, to facilitate engagement.

In FIG. 4 interface assembly 103 is shown as having to parts 402a and 402b, which, under some circumstances, may be rotated about pivot axis 207. In this example part 402b has pins 203, and part 204a has mating holes 204 into which pins 203 engage in different relative rotations. It will be apparent to the skilled person that every pin must have a hole to engage, but that not all pins or holes may be necessarily in the same part 402a or 402b.

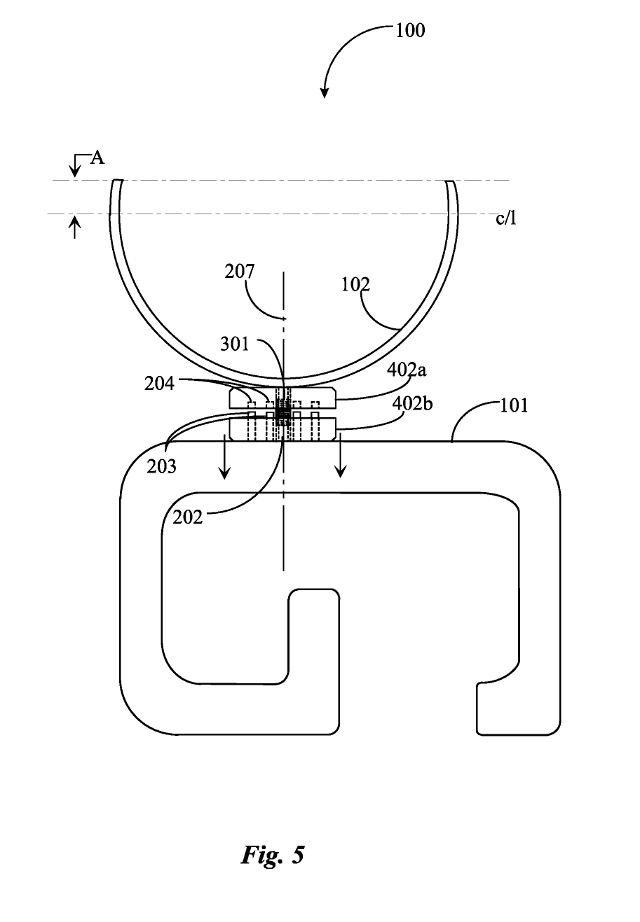

FIG. 5 is a view similar to that of FIG. 4, showing interface assembly 103 opened by withdrawing part 402b relatively from part 402a, such that pins 203 are withdrawn from holes 204, allowing part 402b, which is joined securely to hanger 101, to rotate relative to part 402a, which is joined securely to snap-on spring element 102. In this example the relative rotation is ninety degrees. The parts pivot on a pivot pin 202, around axis 207, and there is a spring element 301 around pin 202, that urges the parts together. A user is enabled by separating the parts 204a and 204b, to rotate to a new position, and to then allow the spring tension to rejoin the parts, with pins 203 re-engaging holes 204. The skilled person will be aware that there are a number of equivalent ways that the spring-loaded pivot mechanism may be accomplished.

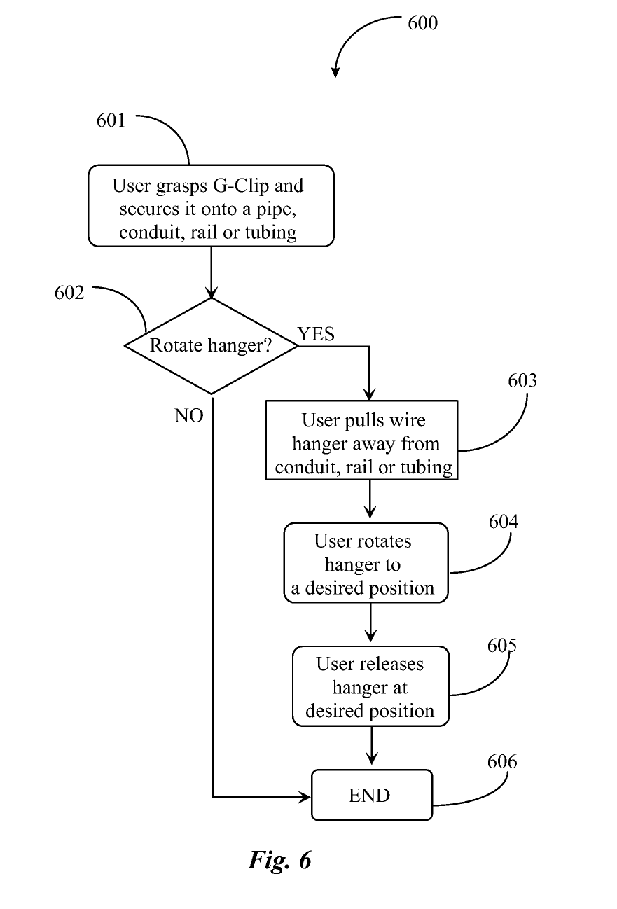

FIG. 6 is a flow diagram 600 illustrating steps in using a G-clip in one embodiment of the invention. At step 601 a user grasps the G-clip and secures it onto a pipe, conduit, rail or tubing in a position that the user may want to secure a wire or loose tubing. At step 602 it is decided whether the hanger 101 needs to be rotated. If no, the steps are complete at step 606. If yes, the user pulls the hanger away from the snap-on spring element, hence to conduit, rail or tube, releasing pins 203 from holes 204. At step 604 the user rotates the hanger to a new desired position. At step 605 the user releases the hanger, and pins 203 re-engage holes 204, and the hanger is secured in position to route and support a wire or loose tubing.

It will be apparent to the skilled person that there may be a great many alterations to parts and assemblies illustrated and described as examples in this specification and drawings, within\the scope of the present invention.

1. A hanger assembly, comprising:
a snap-on spring element, being a structure enabled to engage and disengage a round tubing, conduit or rail, and once engaged to remain in place until manually disengaged, the snap-on spring element having a first axis;
a hanger element providing an open loop adapted to support a loose wire or tubing, the loop having a central plane; and
an interface assembly joining the snap-on spring element and the hanger element, the interface assembly having a first and a second portion joined by a spring-loaded pivot mechanism having a pivot axis oriented at a right angle to the first axis of the snap-on spring element and lying in the central plane of the hanger element, and a mechanism enabling the first and second portions to be rotationally disengaged, rotated, and re-engaged in a plurality of fixed rotational increments.

2. The hanger assembly of claim 1 wherein the open loop of the hanger element further comprises a lip element extending towards the interface assembly thereby partially closing the loop.

3. The hanger assembly of claim 1 wherein one portion of the interface assembly has a circular pattern of holes around the pivot axis, and the other portion has a plurality of pins in the same circular pattern as the holes, and the rotational increments are defined by the number of holes and pins in the circular pattern.

4. The hanger assembly of claim 1 wherein the snap-on spring element comprises a cylindrically-curved section of a flexible plastic material, having a length and an inside radius of curvature, the wall spanning an arc of more than 180 degrees but less than 270 degrees, such that the snap-on spring element may be urged onto a tubing, conduit or rail, expanding the radius of curvature until the snap-on spring element fully engages the tubing, conduit or rail.

5. The hanger assembly of claim 3 wherein a rotational adjustment is made by pulling the second portion of the interface element away from the first portion, against a spring force of the spring-loaded pivot mechanism, disengaging the pins from the holes in the portions, rotating one portion relative to the other to a new rotational position, and allowing the spring to urge the two portions back together, with the pins engaging the holes.

6. A method for routing and supporting a loose wire or tube, comprising steps:
engaging a hanger assembly by a snap-on spring element having a first axis to a round tubing, conduit or rail, presenting thereby a hanger element having an open loop in a first plane connected to a rotationally-adjustable interface assembly, away from the tubing, conduit or rail;
disengaging a first portion of the interface assembly from a second portion against a spring force of a spring-loaded pivot mechanism, thereby disengaging the first portion from the second portion rotationally;
rotating the first portion relative to the second portion until the plane of the loop is substantially vertical;
releasing the first portion against the spring force to re-engage with the second portion, constraining the plane of the loop to remain vertically-oriented; and
hanging a loose wire or tube in the loop.

7. The method of claim 6 wherein the open loop of the hanger element further comprises a lip element extending towards the interface assembly, thereby partially closing the loop.

8. The method of claim 6 wherein one portion of the interface assembly has a circular pattern of holes around the pivot axis, and the other portion has a plurality of pins in the same circular pattern as the holes, and the rotational increments are defined by the number of holes and pins in the circular pattern.

9. The method of claim 6 wherein the snap-on spring element comprises a cylindrically-curved section of a flexible plastic material, having a length and an inside radius of curvature, the wall spanning an arc of more than 180 degrees but less than 270 degrees, such that the snap-on spring element may be urged onto a tubing, conduit or rail, expanding the radius of curvature until the snap-on spring element fully engages the tubing, conduit or rail.

10. The method of claim 6 wherein a loose tube or wire is supported and routed by placing a plurality of hanger assemblies at different positions on one or more tubings, conduits or rails, and routing the loose tube or wire over the plurality of hangers presented.
